(19) United States
(12) Patent Application Publication
(10) Pub. No.: US 2024/0270433 A1
(43) Pub. Date: Aug. 15, 2024

(54) MOLDED PRODUCT WITH CONNECTION ELEMENT

(71) Applicant: PAPACKS SALES GMBH, KOELN (DE)

(72) Inventor: Tahsin Dag, Koeln (DE)

(73) Assignee: PAPACKS SALES GMBH, KOELN (DE)

(21) Appl. No.: 18/568,084

(22) PCT Filed: Jun. 8, 2021
(86) PCT No.: PCT/EP2022/065588

§ 371 Date: Dec. 7, 2023

(30) Foreign Application Priority Data
Jun. 8, 2021 (DE) 10 2021 114 725.5
Feb. 14, 2022 (DE) 10 2022 103 327.9

(51) Int. Cl. B65D 1/02; B65D 1/10; B65D 1/46; B65D 41/04; B65D 43/02; B65D 65/46; B65D 85/804; D21J 1/08; D21J 5/00

(52) U.S. Cl. CPC B65D 1/0207; B65D 1/0246; B65D 1/10; B65D 1/46; B65D 41/04; B65D 43/0231; B65D 65/466; B65D 85/8043; D21J 1/08; D21J 5/00

(57) ABSTRACT

The invention relates to a molded product made of fiber material with a connection element (11′″). In order to achieve a particularly firm anchoring of the connection element (11′″) in the fiber material of the molded product, the connection element (11′″) has a connecting wall (17) with holes (18) through which the fiber material of the molded product projects.

The invention relates to a molded product made of fiber material with a connection element.

It relates in particular to a receptacle with a container made of fibrous material having at least one opening and a cover for the opening, wherein the container has a biodegradable or bioinert coating, wherein an injection-molded connection element locally reinforces at least the region of the opening. However, the problem of the fixed connection of a connection element to a molded product made of fibrous material is not limited to the application of the local reinforcement of a container opening.

EP 2 573 008 B1 discloses a container, in particular a coffee capsule, which is formed from a paper material and has a flange at an open end. A reinforcing ring extending radially beyond the flange is arranged on the flange and may be glued or welded to a cover. The reinforcing ring is made in particular of paper and/or another material which contains at least one resin or rubber.

DE 10 2019 101 545 A1 discloses a receptacle, in particular a coffee capsule, with a cup-shaped container made of fibrous material, which may be closed by means of a cover designated as cap. At an opening, the container has a flange designated as an annular peripheral rim. The flange is surrounded by a reinforcing ring, which is made in particular from an uncoated cardboard material.

A receptacle for holding a cosmetic product is known from FR 2 741 042 A1. The receptacle has a cup-shaped container and an injection-molded outer housing. In particular, the container may be made of polypropylene or another suitable material which does not react chemically with the contents of the container. In particular, the housing may be made of Plexiglas or another material that combines an aesthetic impression with the required technical properties of a housing.

The receptacles known from the state of the art are either not made exclusively from biodegradable components or they have comparatively low mechanical stability.

The underlying problem of the invention is to reliably and permanently connect a molded product made of fiber material to a connection element. This may serve the purpose of providing a receptacle which is formed exclusively from biodegradable components, which has a high gas tightness and a high mechanical stability and the manufacture of which is particularly flexible and cost-effective. However, the technology described here is also advantageous for any other molded product made of fibrous material that is to be connected to any connection element.

The problem is solved in that the connection element has a connecting wall with holes through which the fiber material of the molded product protrudes.

The connection element may thus have a thin connecting wall in which several holes are arranged. The holes are preferably evenly distributed over the surface of the connecting wall. In particular, the connecting wall may be grid-shaped so that the area of the holes is approximately equal to or larger than the area of the webs remaining between the holes. The connection element may be inserted into a suction mold in which the molded product is formed from fiber material. The suction mold is immersed in a pulp, i.e. in a mixture of fibrous material and water. The water is drawn in through a porous wall of the suction mold, whereby the fibrous material is deposited in a layer on the surface of the suction mold. During this process, the connecting wall with holes is kept at a small distance of e.g. 1 mm from the porous wall of the suction mold. In the region of the connecting wall of the connection element with holes, the fibrous material is deposited around the connecting wall and protrudes through the openings, so that the connection element is firmly anchored in the resulting layer of fiber material, which forms the molded product. The fibrous material drawn in may be pressed so that the formed fiber material layer is dewatered with the molded-in section of the connection element.

The connection element may have any shape and fulfill any function. It may be made of any solid material such as wood or light metal, but in particular of a biodegradable plastic. For anchoring in the fiber layer of the molded fiber product, the connection element has a section that is designed as a thin connecting wall with holes. The connecting wall may be embedded in a fiber material layer of the molded fiber product in the manner described above.

As mentioned at the beginning, the molded product made of fiber material was developed starting from a receptacle. The receptacle has a container made of fiber material having at least one opening and a cover for the opening, wherein the container may be the molded product made of fiber material according to the invention and may have a biodegradable coating. Alternatively or additionally, the container may have a bioinert coating, in particular a SiO₂ coating, which is deposited on the inner side of the container in a sol-gel process. If the molded product made of fiber material does not have a sealing function, the coating may be dispensed with.

The molded product, i.e. the container made of fiber material, may be produced from an aqueous pulp with cellulose fibers, as described above. The cellulose fibers are, for example, brought into a mold, which forms the molded product, by means of a simple sieving process using a suction mold. The water is sucked out through pores in the suction mold and the cellulose fibers are deposited on the surface of the suction mold with the pores. In the transfer process, the molded product formed by the suction mold is transferred to a transfer mold so that it is shaped from both sides. Additional thermal processing and pressing methods may be used to improve the surface quality of the molded product. The molded product made of fiber material formed in this way is firm and dimensionally stable.

The container made of fiber material produced in this way may have an opening, a base opposite the opening and a peripheral wall surrounding the opening and the base. The opening and the base may be round, oval or polygonal, for example. A cover is attached or may be attached to the opening of the container, by means of which the opening of the container is closed or may be closed. The cover interacts with the container in such a way that the interior of the container is closed or may be closed off from the environment. The cover may also be biodegradable.

Fiber material without a coating has a certain gas and water. This may be desirable or at least not disadvantageous in certain applications of a molded product. One embodiment of a container made of fiber material described here has a biodegradable coating, so that its gas and water impermeability is increased, especially when the cover interacts with the container. The coating of fiber material is basically known from the prior art. Coatings may be sprayed on, for example. Alternatively or additionally, a coating may be applied by immersing a fiber material in a coating bath and then drying it. For example, the applicant's publication WO 2020/216719 A1 discloses a biodegradable barrier coating for a cellulose substrate, which is well suited for coating the fiber material containers described here.

Arranged on the container may be the connection element, which may locally reinforce the container at least in the region of the opening. The container and the connection element may thus form a receptacle that is locally reinforced at least in the region of the opening. The connection element may be injection-molded and/or made of biodegradable material.

In other words, an injection-molded connection element may be used that interacts with the container in such a way that the container is particularly rigid and dimensionally stable, at least in the region of the opening. For this purpose, the material of the connection element has a higher strength than the fiber material from which the container is formed. The receptacle may therefore absorb higher mechanical loads overall than the container without such a connection element. Since the connection element may be made of a biodegradable material, the receptacle may consist exclusively of biodegradable materials. Biodegradable means that the materials may decompose under certain anaerobic or aerobic conditions. The biodegradable material of the connection element may also be injection moldable. In particular, it may be thermoplastic for this purpose. This means that the material from which the connection element is formed is flowable in a heated state and solidifies when it cools down. Such a change in consistency is reversible in thermoplastic materials. Alternatively, it is also possible that the injection-moldable material is only flowable during processing and hardens irreversibly in the injection-molded state in the manner of duromers or elastomers. It is explicitly pointed out that the injection-moldable material of the connection element may additionally or alternatively also be printable, in particular 3D printable, and/or have multiple parts. The fact that the material of the connection element may be injection molded and/or printed means that different geometries may be produced cost-effectively using a single production system and, if necessary, adapted tools, making the production of the connection element particularly flexible and cost-effective.

In practice, for example, a thermoplastically processable starch is suitable for forming the connection element, as described in the publications EP 0 118 240 A2 or EP 0 397 819 B1.

If the connection element consists of several parts, different parts may be assembled to form different connection elements according to a modular principle, which increases the flexibility and cost efficiency of production. In particular, if the connection element is injection molded, a high surface quality of the connection element can be achieved and easily reproduced.

However, the connection element may also be made of materials other than injection-moldable materials. The proposed connecting wall with holes through which the deposited fiber material forming the molded product protrudes, firmly anchors the connection element, which may serve any purpose, in the resulting fiber material layer.

In practice, the coating of the molded product, in particular the container, may be a primer containing at least one of the following components:
cellulose fibers,
casein,
whey,
agar agar,
psyllium husks
SiO₂.

The primer may be applied to the surface facing into the interior (the inner side) of the container. Additionally or alternatively, the primer may be applied to the surface facing outwards (the outside) of the container. As mentioned above, the coating increases the gas-tightness of the container. This may also increase its strength.

Cellulose nanofibrils or microfibrils may be dissolved in water, for example, and sprayed onto the container. Nanocellulose has cellulose microfibrils with a median diameter in the range from 30 to 100 nm and/or cellulose nanofibrils with a median diameter in the range from 5 to 20 nm. Industrially marketed cellulose fibrils are often a mixture of microfibrils and nanofibrils. In practice, a mixture of 2% by weight of nanocellulose in 98% by weight of water has proven to be effective for the primer. If a higher content of cellulose is selected, deformation of the container due to moisture may be reduced or avoided and the drying time of the primer may be shortened. In practice, a cellulose content in the primer solution of 2 to 10% by weight is suitable.

There are other organic materials that may be used in a primer to increase the impermeability of a container against gas penetration. For example, casein powder may be mixed with water and denatured using calcium hydroxide. The casein increases the tightness and mechanical strength of the container. Casein denatured with calcium hydroxide also becomes water-repellent to a certain extent. It is also possible to denature the casein with sodium bicarbonate, but this does not make it water-repellent.

In practice, 30 g casein powder was left to swell with 100 ml water for around 8 to 10 hours, 30 g calcium hydroxide was added and stirred. After adding another 50 ml of water, the solution was sieved and used for priming. This primer may be applied after the primer with cellulose fibers or as an alternative to the primer with cellulose fibers. The primer may also contain both cellulose fibers and casein.

Whey is also suitable as a component of the primer. Whey may be denatured by heat (90°-100° C.). Whey as a component of the primer also increases the strength of the coated container. The whey coating itself is not water-repellent and must therefore be waterproofed with a second coating.

Finally, gel-forming ingredients such as agar agar (gelatine from algae) or psyllium husks (seed husks of the plantain species Plantago indica, Plantago afra) are suitable for adding to the primer. Agar agar powder, for example, is mixed with water for this purpose and denatured at 100° C. for 1 minute. When it cools, it solidifies and gels. The gel may be applied to the container and forms a thin layer that seals the pores of the fiber material, increases strength and repels water.

A similar effect is achieved when ground psyllium husks are soaked in water and applied to the container after approx. 20 minutes of swelling.

As mentioned, the components of the primer may be dissolved in water jointly and applied as a mixture. However, it is also possible to apply the primer to the container in several layers with different components. All the possible components of the primer mentioned above are biodegradable.

A coating of silicon dioxide SiO₂ may also be applied, which is particularly dense and resistant. Depending on the modification or the degree of order of the silicon dioxide, it is only poorly soluble in water. In any case, it is bioinert, i.e. there is no chemical and/or biological interaction between silicon dioxide and other substances. This coating may be deposited on the inner side of the container using a sol-gel process, for example. The coating may either be applied only to the container or simultaneously to the container and the connection element.

In practice, the material of the connection element may be water-soluble and/or compostable. Water-soluble means that the connection element dissolves in water within a week, preferably within a day, and particularly preferably within a few hours. This means that the connection element may be biodegraded particularly quickly. A polymer is compostable according to the European standard EN13432 if it is converted by microorganisms into CO₂ within 6 months in an industrial composting plant, wherein the initial mass contains a maximum of 1% additives that are classified as harmless. Preferably, not only the connection element is compostable, but all components, i.e. the connection element, the container and possibly the cover, are compostable. In practice, all components may be compostable without industrially defined conditions. This means that composting is also possible without an industrial composting plant. Even if the molded fiber product and the connection element are not disposed of with the sorted compost waste but are released into the environment, they will decompose within a few months. In contrast, the vast majority of compostable polymers, including frequently used polylactides, are usually only biodegradable under industrially defined conditions or over long periods of several years. The ecological footprint of the molded product made of fiber material and the connection element is therefore considerably minimized compared to receptacles made of many other materials with similar mechanical stability.

The connecting wall with holes may achieve a particularly stable positive-locking connection. If the molded product made of fiber material is designed as a container with an opening and the connection element has a connecting wall surrounding the opening of the container and comprising holes through which the fiber material of the container protrudes, the connection element is anchored in the region of the opening. The connection element may have an annular thin connecting wall with holes arranged therein. In particular, the connecting wall may be grid-shaped so that the area of the holes is approximately equal to or larger than the area of the webs remaining between the holes. The connection element may be inserted into a suction mold in which the container is formed from fiber material. The connecting wall then has a small distance of e.g. 1 mm to a porous wall of the suction mold. Water may be sucked out of a pulp through the porous wall of the suction mold so that the fiber material is deposited on the porous wall of the suction mold. In the region of the connecting wall with holes of the connection element, the deposited fiber material protrudes through the holes and thus anchors the connection element firmly in the resulting pulp layer that forms the container. When the deposited pulp is pressed, the pressing may be carried out, for example, by an inflatable pressing tool that is pressed against the inner side of the formed container of fiber material, thus dewatering the container wall of fiber material with the molded-in section of the connection element.

Furthermore, the molded product of fiber material may be pressed with the connection element at a temperature at which, in the case of a thermoplastic connection element, the injection-molded material softens or melts on its surface and penetrates into the pores of the fiber material.

If the molded fiber product and the connection element form a receptacle with a cover, in practice the cover of the receptacle may be designed as a sealing film. Sealing films may consist of densely coated fiber material. They are thin, flexible and gas-tight at the same time. In particular, the coating of the sealing film may be identical to the coating of the container. However, it may also have a different composition. If the coating of the cover is identical to the coating of the container and/or these two coatings may be dissolved using the same solvent, the container and the cover may be joined together particularly easily and securely by means of material bonding. For example, the coated and not yet completely dry cover may be placed on the opening of the container in such a way that the opening is completely covered. The container and the cover may then be pressed together, whereby the coating of the container is dissolved and later dries in conjunction with the coating of the cover. By covering and joining in this way, the receptacle has minimal material consumption and only a few different materials, which is advantageous for biodegradability and/or compostability.

Additionally or alternatively, the cover may be made of the same material as the connection element. In this case, the cover may be a cap, in particular a screw-on cap. A cap covers the opening of the container, may be detached from the opening and may be reattached. For this purpose, the cover is positively connected to the container and/or the connection element, for example by screwing the cover with an internal thread onto an external thread of the container or the connection element. Of course, the positive connection may also be achieved by other suitable design measures, such as latching protrusions and complementary receiving parts or a bayonet catch. If the cover, like the connection element, is made of injection-molded material, the receptacle is particularly strong and leak-proof.

Of course, the receptacle may also have a plurality of covers, for example a sealing film as described above, and additionally a cap arranged on top that may be screwed to the container or the connection element.

In practice, the primer described above may be a first coating and the molded product/container may have a second coating applied at least locally. The second coating may be applied to the primer. If the primer is only applied to one side of the container, i.e. either the inner side or the outer side, it is also possible that the second coating is additionally or alternatively applied to the side of the container on which the primer is not applied. The second coating may increase the gas-tightness and/or the strength of the container. In particular, the second coating may be applied to the container in such a way that the strength of the container is increased at least in a region in which the connection element and/or the cover are arranged. Due to the increased strength, the container may absorb a high or cyclical load from the connection element and/or the cover particularly well in this region.

In practice, the second coating may be made of linseed oil, carnauba wax and/or beeswax, i.e. natural waxes and/or oils/fats. Natural waxes and/or lipids consist mainly of esters of fatty acids and are readily biodegradable as oil-soluble products according to the CEC-L-33-A-93 test method.

Linseed oil is used to improve the malleability of the oil-wax mixture, which forms the second coating, and to minimize brittleness after drying. Pharmaceutical, i.e. completely clarified, pure linseed oil should be used. Linseed oil is one of the few hardening oils and has been used for centuries for wood impregnation. However, a linseed oil coating alone is open-pored, i.e. allows water and air to pass through to some extent, and is not suitable for permanently waterproof food packaging.

Carnauba wax is a very hard, tropical wax with a high melting temperature (approx. 85-89° C.). It has hardly any odor or taste of its own and is waterproof. It is very brittle when dry and cures within seconds. Due to its hardness, it is also very resistant to abrasion. It is approved for food packaging and has long been used as a coating to increase the shelf life of e.g. mangoes, sweets etc.

Beeswax is a wax produced in Europe, among other places, which is less hard than carnauba wax. In a mixture with carnauba wax, beeswax helps to reduce brittleness. It has hardly any odor or taste of its own and is also approved for use in combination with food. Its melting point is approx. 65° C.

In practice, the connection element may be designed as a reinforcing ring. The reinforcing ring may have an elongated section in the axial direction in the form of a sleeve or a pipe section. The elongated section can, for example, form the connecting wall with holes. The reinforcing ring may be embedded with the elongated section in the peripheral wall of the container in particular. This gives the connection element a tighter fit on the container.

In practice, the container may have a flange. The flange is formed integrally with the container of coated fiber material. In particular, the flange may run around the peripheral wall in the region of the opening. This provides a large surface to which the cover may be attached.

If the container has the flange and the connection element is designed as a reinforcing ring, the reinforcing ring may also rest against a side of the flange facing the base of the container or a side of the flange opposite to it (i.e. a side facing upwards). Such designs of the molded fiber product and the connection element are particularly suitable as, for example, beverage powder portion packaging, especially as a coffee capsule. The flange and the adjacent region of the container are mechanically reinforced by the reinforcing ring. Such reinforcement is particularly advantageous for coffee capsules with a container made of fiber material, since a gripping mechanism of coffee machines for coffee capsules engages the flange in order to move the coffee capsule from a first position to a second position. The reinforcing ring on the flange provides the coffee capsules of fiber material with the necessary strength.

A coffee portion pack in the form of a capsule consisting of the molded fiber product with connection element described here has a high degree of impermeability, which is much higher than that of conventional coffee pods made of uncoated cellulose fibers, and a better environmental compatibility than conventional coffee capsules made of aluminum. As a result, coffee may be stored for a long time without producing a lot of waste. The coffee capsule described here consists solely of natural raw materials and may be easily biodegraded and/or composted.

Of course, it is also possible to form the molded fiber product with the connection element as described above as a receptacle with a resealable screw cap and to fill it with cosmetics, e.g. creams, or with non-perishable products, e.g. screws.

The invention also relates to a method of manufacturing a molded product with a connection element according to claims 8 to 12. In the case of a receptacle comprising a container made of fiber material, a cover and a biodegradable coating, the connection element arranged on the container may be made of biodegradable material and at least locally reinforce the container. The method may comprise at least one of the following method steps:
suction of fiber material from a pulp using a suction mold and compaction of the fiber material into the container;
dewatering and drying the container;
coating the container with a primer;
producing, in particular injection molding of the connection element;
attaching the cover.

With regard to details of the respective process steps, reference is made to the above description of the features thus produced. The advantages mentioned in connection with these features apply to the method accordingly.

As already described above, if the molded product forms a container, the container may have two coatings. In particular, the second coating may be applied by immersing the container in a hot bath of natural waxes and/or oils or fats. The soaked container may then be hot-pressed and cooled. The hot pressing of the impregnated container fixes its geometry, and the second coating may penetrate into unfilled pores of the fiber material.

Further practical embodiments and advantages of the invention are described below in connection with the drawings.

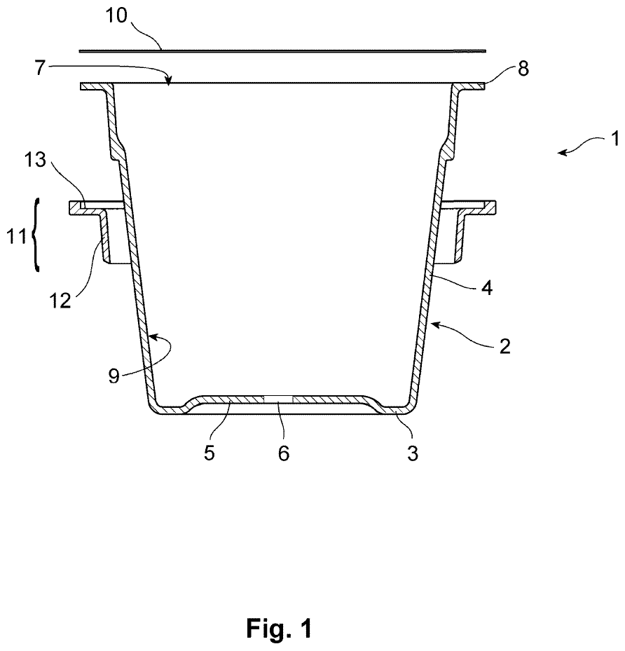

FIG. 1 shows a receptacle in a first embodiment as a coffee capsule in a vertically sectioned exploded view without connecting wall having holes;

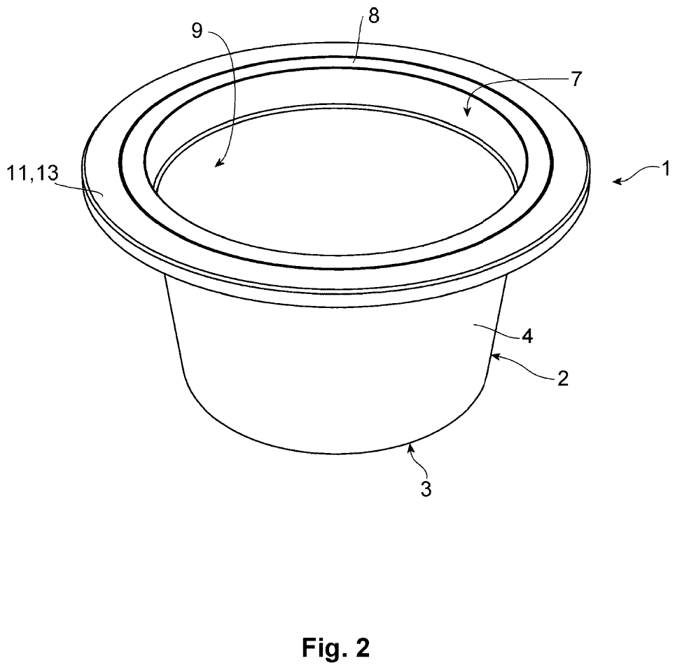

FIG. 2 shows the receptacle from FIG. 1 without cover, in an oblique view from above;

FIG. 3 shows the receptacle from FIG. 1 in an oblique view from below;

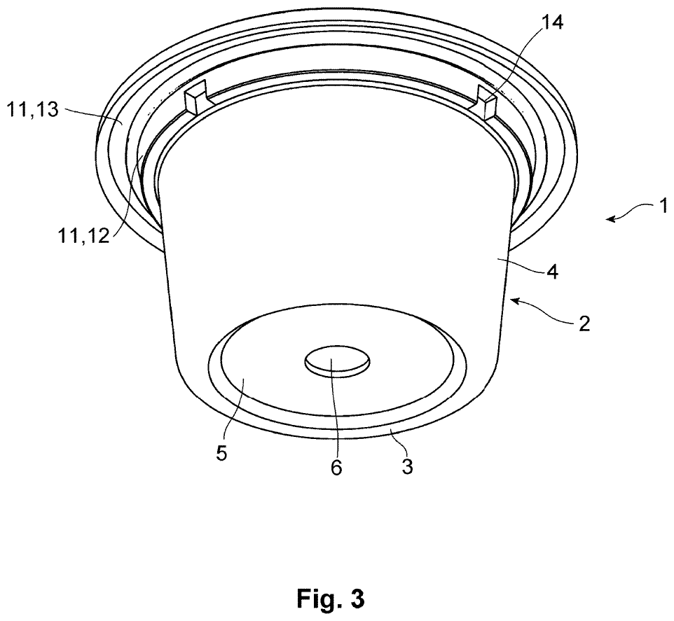

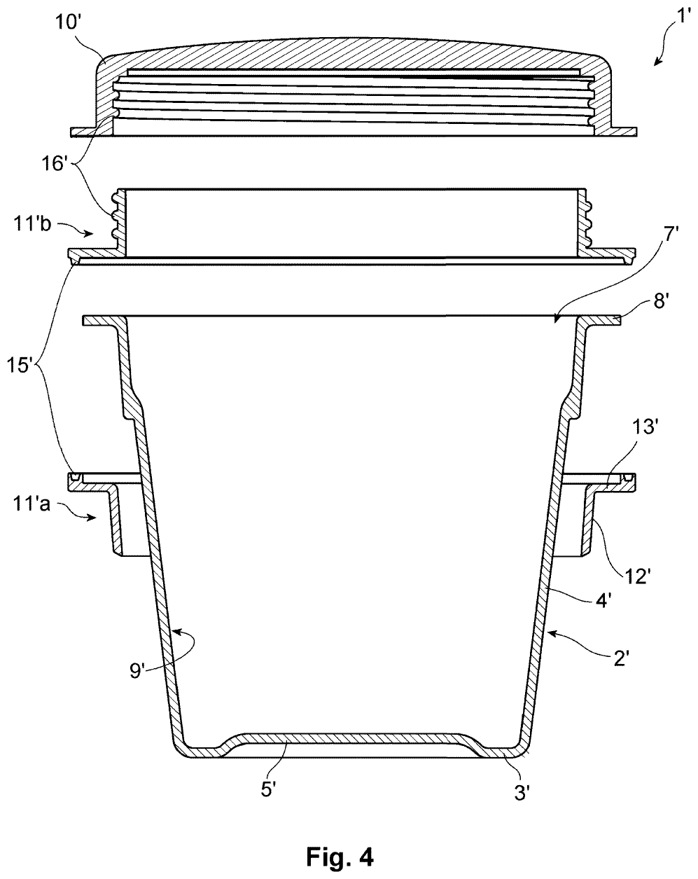

FIG. 4 shows the receptacle in a second embodiment as a jar for cosmetic products in a vertically sectioned exploded view, also without connecting wall having holes;

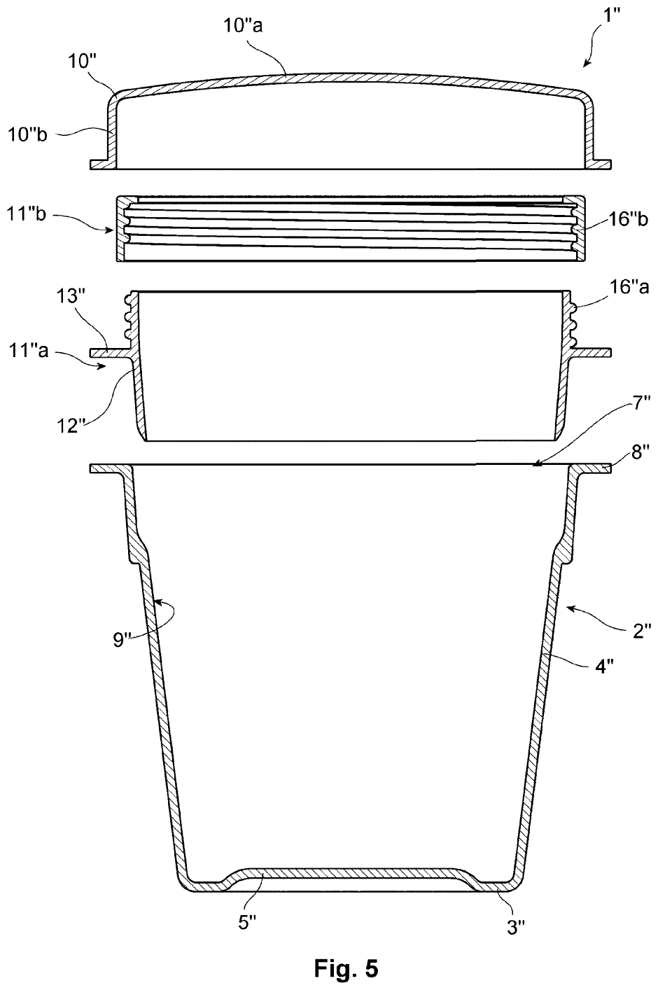

FIG. 5 shows the receptacle in a third embodiment as a jar for cosmetic products in a vertically sectioned exploded view, again without connecting wall having holes;

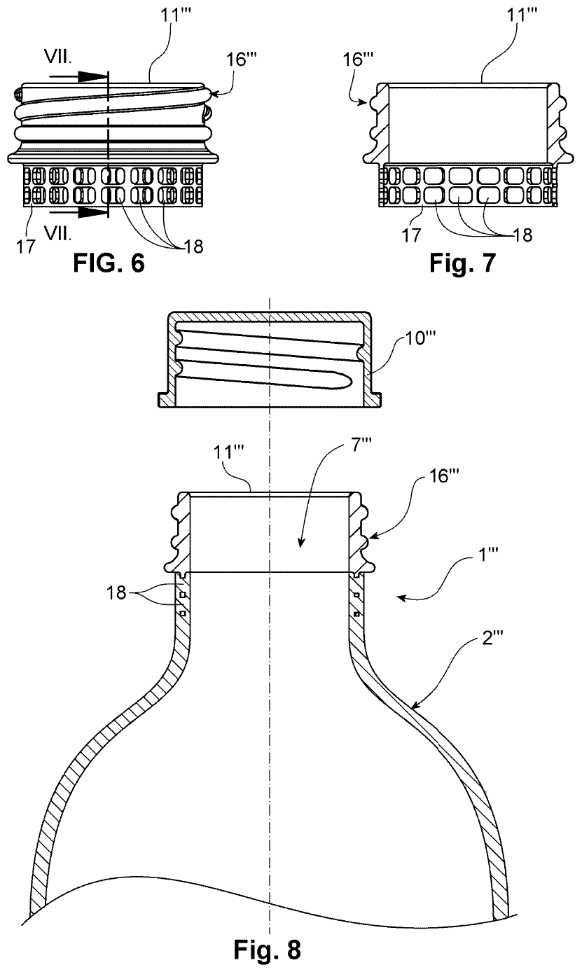

FIG. 6 shows a side view of a connection element with connecting wall and openings for a molded product made of fiber material designed as a container;

FIG. 7 shows sectional view of the connection element from FIG. 6 along section line VII-VII;

FIG. 8 shows bottle-shaped embodiment of a molded fiber product with the connection element from FIGS. 6 and 7 with cover;

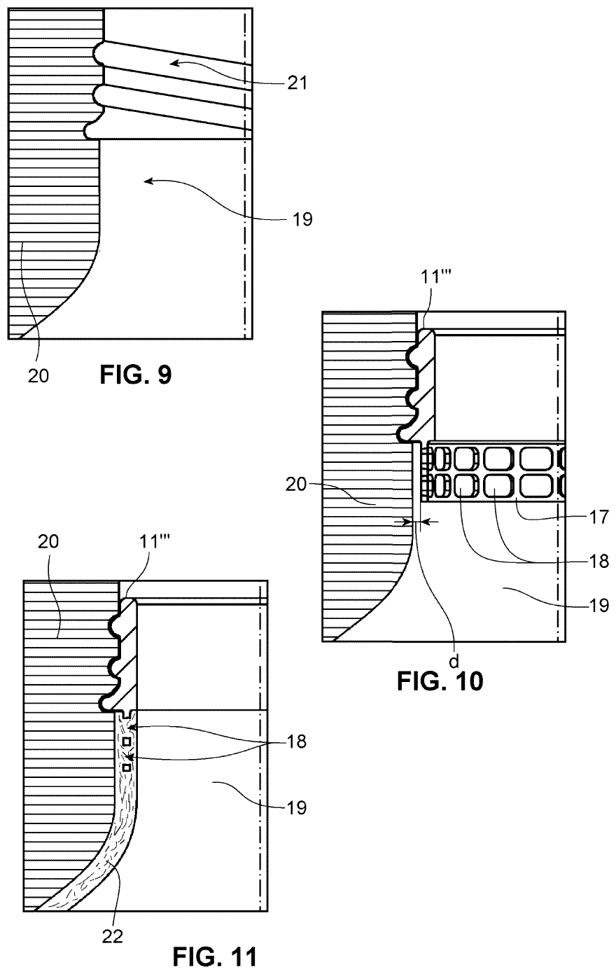

FIG. 9 shows enlarged plan view of a section of a suction mold for producing the bottle of FIG. 8;

FIG. 10 shows the section of the suction mold from FIG. 9 with inserted connection element from FIGS. 6 and 7 made of injection-molded material;

FIG. 11 shows the section of the suction mold from FIG. 9 with inserted connection element and suctioned fiber layer.

FIGS. 1 to 3 show a receptacle 1 that is designed as a coffee capsule. The receptacle 1 has a container 2 and is essentially rotationally symmetrical. It has a base 3 and a peripheral wall 4 surrounding the base 3. A central and rotationally symmetrical recess 5 with a perforation region 6, which is also rotationally symmetrical and centrally arranged therein, is formed in the base 3. The perforation region is to be pierced by at least one needle in order to allow liquid fed into the receptacle 1 under pressure to escape. The recess 5 is oriented towards the inside of the container, i.e. towards an opening 7 of the container 2 opposite the base 3. At the opening 7, the container 2 has a flange 8 that rotationally symmetrically surrounds the opening 7 and the peripheral wall 4. The flange 8 extends outwards from the peripheral wall 4 in a radial direction and is oriented essentially parallel to the base 3.

The container 2 with the base 3, the peripheral wall 4 and the flange 8 is formed in one piece from fiber material. A primer (not shown) is applied to the inner side 9 of the container 2 facing into the container interior and to the upward-facing surface of the flange 8. The primer can, for example, be formed from cellulose and casein and is therefore biodegradable. However, it may additionally or alternatively also contain other biodegradable components, for example whey, agar agar and/or psyllium husks. The primer increases the gas-tightness and mechanical stability of the container 2.

As indicated in FIG. 1, the opening 7 is covered with a cover 10, which is designed as a sealing film. The sealing film 10 is flexible and at the same time gas-tight. It is fixed in place on the flange 8 and thus seals the interior of the container from the environment. For fixing on the flange, the sealing film 10 has the same coating (not shown) on the surface oriented in the direction of the flange 8 as the inner side of the container 9 and the upward-facing surface of the flange 8. The coatings of the sealing film 10 and the flange 8 are bonded to each other.

In the region of the opening 7, the receptacle 1 has an injection-molded connection element 11, which is formed from a water-soluble and biodegradable thermoplastic. The biodegradable thermoplastic may be a thermoplastically processable starch as described in the publications EP 0 118 240 A2 or EP 0 397 819 B1. The connection element is designed as a reinforcing ring 11 with a vertical ring section 12 and a horizontal ring section 13. With the vertical ring section 12, the reinforcing ring 11 rests on the outside of an upper section of the peripheral wall 4. As may be clearly seen in FIG. 3, indentations 14 are arranged on the vertical ring section 12, with which the coffee capsule 1 may be locked in a holding device of a coffee machine (not shown). The vertical ring section 12 may also be designed as a connecting wall having holes and may be embedded in the fiber material during the manufacture of the molded fiber material product (container 2) in the fiber molding process.

The horizontal ring section 13 protrudes from an upper end of the vertical ring section 12 in a radial direction outwards beyond the flange 8. A radial recess for receiving the flange 8 is formed in the upper end of the horizontal ring section 13. The flange 8 and the horizontal ring section 13 are therefore complementary in design, so that the flange 8 and the horizontal ring section 13 terminate at the top in a common plane. The flange 8 is therefore completely enclosed by the horizontal ring section 13 and the sealing film 10.

The sealing film and the reinforcing ring may be bonded together by an adhesive, preferably a biodegradable adhesive.

As an alternative to the form-fit connection between the connection element 11 and the container 2 shown here, it is possible to connect the connection element 11 to the container 2 by injection-molding it to the container 2.

FIG. 4 shows an alternative embodiment of the receptacle 1′ as a jar for holding cosmetic products. Unless otherwise indicated, similar structural elements of FIG. 4 are provided with the same reference signs as already mentioned above and are provided with a single dash to distinguish them from the structural elements of the coffee capsule. The jar 1′ also has a container 2′ with a base 3′, a peripheral wall 4′, a central recess 5′ in the base 3′, an opening 7′ opposite the base 3′ and a flange 8′ extending radially outwards from the peripheral wall 4′. The jar 1′ is essentially rotationally symmetrical. A primer made of biodegradable material, not shown here, is also applied to the inner side 9′ of the container 2′, which increases the gas-tightness and mechanical stability of the container 2′.

A cover for the jar 1′ shown here is designed as a cap 10′. To attach the cap 10′ to the container 2′ and to reinforce the container 2′ in the region of the opening 7′, a two-part connection element 11′ is positively connected to the container 2′.

The two-part connection element 11′ is composed of a lower support ring 11′a and an upper threaded ring 11′b. As described above in connection with the coffee capsule 1, the lower support ring 11′a rests on the outside of the peripheral wall 4′ with a vertical ring section 12′ and on the flange 8′ with a horizontal ring section 13′. The vertical ring section 12′ may also be designed as a connecting wall with holes and may be embedded in the fiber material during the manufacture of the molded fiber material body (container 2′) in the fiber molding process. The horizontal ring section 13′ projects radially beyond the flange 8′. The horizontal ring section 13′ also has a recess in the end oriented towards the cap 10′, in which the flange 8′ is received. Thus, a surface of the flange 8′ oriented towards the cap 10′ and a surface of the horizontal ring section 13′ oriented towards the cap 10′ are in the same plane. The upper threaded ring 11′b has the same outer diameter as the lower support ring 11′a. The inner diameter of the upper threaded ring 11′b essentially corresponds to the diameter of the opening 7′. The upper threaded ring 11′b is attached to the horizontal ring section 13′ of the lower support ring 11′a, which extends radially beyond the flange 8′, so that the flange 8′ is enclosed by the horizontal ring section 13′ of the lower support ring 11′a and by the upper threaded ring 11′b. To attach the two-part connection element 11′ to the container 2′, for example, the lower support ring 11′a may be pushed from below, i.e. past the base 3′, past the peripheral wall 4′ of the container 2′ until the lower support ring 11′a is in contact with the flange 8′ and the upper threaded ring 11′b may be pressed onto the flange 8′ and the lower support ring 11′a from above. A tongue and groove connection 15′ between the lower support ring 11′a and the upper threaded ring 11′b may form a positive connection. The groove and the tongue of the tongue and groove connection 15′ are latched or glued together. After the connection, the lower support ring 11′a and the upper threaded ring 11′b are flush with each other in the radial outward direction.

The cap 10′ may be connected to and disconnected from the upper threaded ring 11′b via a threaded connection 16′. For this purpose, an external thread is arranged on the upper threaded ring 11′b and an internal thread on the cap 10′. When the cap 10′ and the upper threaded ring 11′b are screwed together via the thread 16′, the cap 10′ and the upper threaded ring 11′b are radially flush on the outer side and the inner side of the container is sealed gas-tight against the environment. When the cap 10′ is unscrewed from the upper threaded ring 11′b, the inner side of the container communicates with the environment via the opening of the upper threaded ring 11′b.

FIG. 5 shows a further alternative embodiment of the receptacle 1″ as a jar for holding cosmetic products. Unless otherwise indicated, similar structural elements of FIG. 5 are provided with the same reference signs as mentioned above and are provided with two dashes to distinguish them from the other embodiments. The jar 1″ also has a container 2″ with a base 3″, a peripheral wall 4″, a central depression 5″ in the base 3″, an opening 7″ opposite the base 3″ and a flange 8″ extending radially outwards from the peripheral wall 4″. In the region of the opening, the container 2″ is slightly widened to accommodate a connection element 11″. The jar 1″ is essentially rotationally symmetrical. A primer made of biodegradable material, not shown here, is also applied to the inner side 9″ of the container 2″, which increases the gas-tightness and mechanical stability of the container 2″. The connection element 11″ in the region of the opening 7″ is made in two parts and is connected to the container 2′ in a form-fit and material-fit manner. A cover for the jar 1″ shown here is also designed as a cap 10″, which interacts with the connection element 11″.

The two-part connection element 11″ is composed of an inner support ring 11″a and an outer threaded ring 11″b. The inner support ring 11″a has a vertical ring section 12″ and a horizontal ring section 13″, wherein the horizontal ring section 13″ surrounds the vertical ring section 12″ approximately halfway up and at a right angle on the outside. In the region above the horizontal ring section 13″, the vertical ring section 12″ has an external thread 16″a. The region of the vertical ring section 12″ below the horizontal ring section 13″ has an essentially smooth cylindrical outer surface that is complementary to the surface of the widened region of the container 2″. The inner support ring 11″a is thus inserted into the container 2″. It rests with the vertical ring section 12″ on the inner side of the peripheral wall 4″ and with the horizontal ring section 13″ on the top of the flange 8″. The abutting surfaces are bonded together to ensure a high level of tightness and mechanical stability. Bonding may also be achieved, for example, by fitting the container 2″ and the vertical ring section 12″ into each other and pressing them together at a temperature at which the injection-molded material softens or melts. The melted material of the vertical ring section 12″ then adheres to the container 2″ and may penetrate its pores. However, bonding is optional; a secure joint may also be achieved by a press fit, for example. As an alternative to inserting the inner support ring 11″a into the container 2″, the vertical ring section 12″ below the horizontal ring section 13″ may also be designed as a connecting wall with holes and embedded in the fiber material of the container wall during the production of the molded fiber material product (container 2′) using the fiber molding process. Radially on the outside, the horizontal ring section 13″ is flush with the flange 8″. The inner diameter of the upper threaded ring 11′b essentially corresponds to the diameter of the opening 7′. The region of the vertical ring section 12″ with the external thread 16″a protrudes upwards from the container 2″.

The outer threaded ring 11″b has an internal thread 16″b on the inward-facing side, which is complementary to the external thread 16″a of the inner support ring 11″a. The outward-facing surface of the outer threaded ring 11″b is smooth cylindrical and its diameter is smaller than the diameter of the horizontal ring section 13″. Thus, when the outer threaded ring 11″b is screwed onto the inner support ring 11″a, the horizontal ring section 13″ projects radially beyond the outer threaded ring 11″b.

The cap 10″ has a curved top surface 10″a and a ring section 10″b surrounding it. The inner diameter of the ring section 10″b corresponds to the outer diameter of the outer threaded ring 11″b. This means that the cap 10″ may be placed on the outer threaded ring 11″b from above and removed again.

In the present case, the cap 10′, 10″, the lower support ring 11′a, the inner support ring 11″a, the upper threaded ring 11′b and the outer threaded ring 11″b are injection-molded from a water-soluble and compostable thermoplastic. As an alternative to the form-fit connection shown here between the two-part connection element 11′, 11″ and the container 2′, 2″, it is possible to form the connection element 11′, 11″ in one piece and/or to connect the connection element 11′, 11″ to the container 2′, 2″ by injection-molding it to the latter.

FIGS. 6 and 7 show a side view and a longitudinal section of a further embodiment of a connection element 11′″ and FIG. 8 shows a receptacle 1′″ designed as a bottle with this connection element 11′″ and a container 2″. The upper section of the connection element 11′″ again has an external thread 16′″ onto which a cover 10′″ in the form of a screw cap may be screwed. The container 2′″ can, for example, hold a beverage, a detergent or another liquid, gel or powdery material. The receptacle 1′″ is sealed tightly by the screw cap 10′″. To ensure that the connection element is connected to the container 2′″ in a particularly tight and durable manner, it has a thin annular connecting wall 17 below the external thread 16′″, which surrounds the opening 7′″ of the container 2′″. The connecting wall 17 is provided with a plurality of holes 18, between which there are webs that form the connecting wall 17.

FIGS. 9-11 show an upper section of a multi-part suction mold 19 with a porous wall 20 for producing the container of FIG. 8. The suction mold 19 has two, three, four or more parts to enable the removal of the molded product formed in the suction mold 19. The porous wall of the suction mold may be achieved in the conventional way by a base body made of plastic or metal with suction channels, into which a sieve-like structure is inserted to form the porous wall. In the embodiment shown, the porous wall 20 of the suction mold 19 is produced using a 3D printing process, whereby liquid-permeable channels are embedded in the material of the porous wall 20.

The suction mold 19 has an upper receiving portion 21 for the injection-molded connection element 11′″. To produce the pulp container 2′″, the connection element 11′″ is inserted into the receiving section 21 of the suction mold 19 in such a way that the connecting wall 17 of the connection element 11′″ has a small distance d in the order of 1 mm from the porous wall 20 of the suction mold 19. The suction mold 19 is then immersed in pulp and water is sucked out through the porous wall 20 so that a layer of fiber material 22 is deposited on the porous wall 20 of the suction mold 19. The fiber material 22 penetrates through the holes 18 of the connecting wall 17 of the connection element 11′″ and protrudes through the holes 18.

In practice, the fiber layer of the container 2′″ may then be compacted by pressing an inflatable pressing tool (not shown) against the inner side of the deposited fiber layer. The fiber layer is thereby dewatered and compacted and firmly encloses the webs between the holes 18 in the connecting wall 17.

Rotationally symmetrical receptacles are shown in the drawings. The openings have a circular clear cross-section. The skilled person will recognize that the receptacles and their openings may have a shape that deviates from the circular shape. For example, the containers and their openings may be square. In this case, the connection elements also have the shape of a square ring that encloses a square opening.

The features of the invention disclosed in the present description, in the drawings and in the claims may be essential, both individually and in any combination, for the realization of the invention in its various embodiments. The invention is not limited to the described embodiments. It may be varied within the scope of the claims and taking into account the knowledge of the skilled person skilled in the art.

### LIST OF REFERENCE SIGNS

1 receptacle, coffee capsule
2 molded product made of fiber material, container
3 base
4 peripheral wall
5 recess
6 perforation region
7 opening of the container
8 flange
9 inner side of container
10 cover, sealing film
11 connection element, reinforcement ring
12 vertical ring section
13 horizontal ring section
14 indentations
1′ receptacle, cream jar
2 molded product made of fiber material, container
3′ base
4 peripheral wall
5 recess
7 opening the container
8′ flange
9 inner side of container
10′,10′″ cover, cap
11′ two-part connection element
11′a lower support ring
11′ upper threaded ring
12′ vertical ring section
13′ horizontal ring section
15′ tongue and groove connection
16′ threaded connection
1″ receptacle, cream jar
2″ molded product made of fiber material, container
3″ base
4″ peripheral wall
5″ recess
7″ opening of the container
8″ flange
9″ inner side of container
10″ cover, cap
10″a cover area
10″b ring section
11″ two-part connection element
11″a inner support ring
11″b outer threaded ring
12″ vertical ring section
13″ horizontal ring section
16″ threaded connection
16″a external thread
16″b internal thread
1′″ receptacle, bottle
2′″ molded product made of fiber material, container
7′″ opening
11′″ connection element
17 connecting wall
18 hole
19 suction mold
20 receiving portion
21 porous wall
22 fiber material
d distance

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A biodegradable container with a replaceable covering, comprising:
a body comprising a fibrous material;
a connecting element comprising a threaded neck and a connecting wall with an interior wall, an exterior wall, and a plurality of openings; and
a cover comprising a top and a side wall with a threaded interior;
wherein the connecting wall is hollow, such that a gap exists between the interior wall and the exterior wall;
wherein the interior wall and the exterior wall extend into the body;
wherein the fibrous material of the body passes through the plurality of openings in the interior wall and the exterior wall to fill both the plurality of openings and the gap between the interior wall and the exterior wall;
wherein the fibrous material of the body is dewatered and compacted, forming a continuous, fibrous web woven through the plurality of openings and the gap between the interior wall and the exterior wall;
wherein the threaded interior of the cover is configured to form a reversible threaded connection with the threaded neck of the connecting element, such that the cover is configured to be removed from the threaded neck and reconnected to the threaded neck.

14. The container of claim 13, wherein the top of the cover and the threaded neck are flush when the reversible threaded connection is formed such that the interior of the container is gas-tight with respect to a surrounding environment.

15. The container of claim 13, wherein the container is coated with a first biodegradable coating or a first bioinert coating.

16. The container of claim 15, wherein the container is coated with a second biodegradable coating or a second bioinert coating.

17. The container of claim 15, wherein the first biodegradable coating or the first bioinert coating is a primer including cellulose fibers, casein, whey, agar-agar, psyllium husks, and/or silicon dioxide.

18. The container of claim 16, wherein the second biodegradable coating or the second bioinert coating includes linseed oil, carnauba wax, and/or beeswax.

19. The container of claim 13, wherein the connecting element is a ring, wherein the connecting element surrounds an opening of the body of the container, and wherein the connecting element mechanically reinforces the opening of the body of the container.

20. The container of claim 13, wherein the cover and the connecting element are comprised of the same material.

21. The container of claim 13, wherein the connecting element comprises a biodegradable material.

22. A method for producing a biodegradable container with a threaded cover, comprising:
inserting a connecting element into a suction mold with a porous wall, wherein the connecting element comprises a connecting wall with a plurality of openings;
immersing the suction mold into an aqueous pulp suspension, wherein the aqueous pulp suspension comprises a fibrous material and an aqueous component, wherein the aqueous pulp suspension passes through the plurality of openings;
suctioning the aqueous pulp suspension through the suction mold such that the aqueous component passes through the porous wall while the fibrous material accumulates on the porous wall, the connecting wall, and in the plurality of openings of the connecting wall; and
pressing and dewatering the fibrous material to form a body of the container, wherein the connecting element is firmly anchored in the fibrous material of the body.

23. The method of claim 22, wherein the connecting element is threaded, and wherein a threaded cover is attached to the connecting element.

24. The method of claim 22, wherein the distance from the connecting wall to the porous wall of the suction mold is at least 1 mm.

25. The method of claim 22, further comprising applying a cover to the connecting element, wherein the cover forms a gas-tight seal with the connecting element.

26. The method of claim 22, further comprising coating the fiber material of the body and/or the connecting element with a primer.

27. The method of claim 26, further comprising coating the fiber material of the body and/or the connecting element with a second coating, heat-pressing the container, and cooling the container.

28. A biodegradable container with a replaceable covering, comprising:
a body made of a fibrous material comprising a container flange and a peripheral wall;
an inner support ring comprising an external threaded section, a horizontal flange, and a connecting wall;
an outer threaded ring with an interior threaded section and an external threaded neck; and
a cover comprising a top and a side wall with a threaded interior;
wherein the body includes an opening;
wherein the container flange of the body extends radially outward from the opening, wherein the horizontal flange of the inner support ring is configured to abut the container flange of the body;
wherein the external threaded section of the inner support ring is configured to form a reversible threaded connection with the interior threaded section of the outer threaded ring, such that the outer threaded ring is configured to be removed from the inner support ring and reconnected to the inner support ring; and
wherein the threaded neck of the outer threaded ring is configured to form a reversible threaded connection with the threaded interior of the cover, such that the cover is configured to be removed from the threaded neck and reconnected to the threaded neck.

29. The container of claim 28, wherein at least a portion of the peripheral wall surrounding the opening is flared, wherein the connecting wall is angled to abut the interior surface of the flared portion of the peripheral wall.

30. The container of claim 28, wherein the top of the cover and the threaded neck are flush when the reversible threaded connection is formed, and wherein the external threaded section of the inner support ring and the interior threaded section of the outer threaded ring are flush when the reversible threaded connection is formed, such that the interior of the container is gas-tight with respect to a surrounding environment.

31. The container of claim 28, wherein the body, the inner support ring, and/or the outer threaded ring are coated with a primer including cellulose fibers, casein, whey, agar-agar, psyllium husks, and/or silicon dioxide.

32. The container of claim 31, wherein the body, the inner support ring, and/or the outer threaded ring are coated with a second coating comprising linseed oil, carnauba wax, and/or beeswax.
